(19) United States
(12) Patent Application Publication
(10) Pub. No.: US 2026/0220562 A1
(43) Pub. Date: Jul. 30, 2026

(54) ALLOCATION TIME PREDICTION

(71) Applicant: GRABTAXI HOLDINGS PTE. LTD., Singapore (SG)

(72) Inventors: Aloisius STEPHEN, Singapore (SG); Xue Fang NG, Singapore (SG); Jia CHEN, Singapore (SG)

(21) Appl. No.: 19/146,636

(22) PCT Filed: Dec. 5, 2023
(86) PCT No.: PCT/SG2023/050806

§ 371 Date: Jul. 9, 2025

(30) Foreign Application Priority Data
Jan. 9, 2023 (SG) 10202300064Q

(51) Int. Cl. G06Q 10/0631; G06N 20/00; G06Q 50/47

(52) U.S. Cl. CPC G06Q 10/06311; G06N 20/00; G06Q 50/47

(57) ABSTRACT

Systems and methods for prediction of allocation time in a ridesharing service by retrieving historical rideshare allocation records, generating training data based on the retrieved historical rideshare allocation records, training a machine learning model to predict an allocation probability by each candidate allocation time based on the generated training data, receiving a request for a ride, processing the request attributes using the trained machine learning model to estimate an allocation time for the request.

### TECHNICAL FIELD

This disclosure generally relates to methods and systems for prediction of time to allocate drivers to passenger requests in a ridesharing service.

### BACKGROUND

This background description is provided for the purpose of generally presenting the context of the disclosure. Contents of this background section are neither expressly nor impliedly admitted as prior art against the present disclosure.

With the growth in ridesharing services, platforms enabling the ridesharing services have amassed a significant volume of data relating to drivers, passengers and rides undertaken by passengers. The volume of data relating to rides continues to grow exponentially with the ever-increasing reach of such services. The data may include data relating requests for ridesharing services, data of responses by providers of ridesharing services, data of outcomes relating to allocation of providers of ridesharing services to passengers and data of timing of various events associated with a ride. The data amassed by ridesharing platforms presents an opportunity to improve the experience of users of the ridesharing service and provide more predictable outcomes to all users of the service.

It is desired to address or ameliorate one or more disadvantages or limitations associated with the conventional systems and methods for prediction of allocation time in relation to ridesharing requests, or to at least provide a useful alternative.

### SUMMARY

In one embodiment, the present disclosure provides a system for prediction of allocation time in a ridesharing service, the system comprising:
one or more processor (processor(s));
a memory comprising instructions that when executed by the processor(s) cause the processor(s) to:
retrieve historical ridesharing allocation records, the records comprising actual allocation time values and historical request attributes;
generate training data based on the retrieved historical rideshare allocation records, wherein each record in the training data comprises an allocation status label and a candidate allocation time, the allocation status label indicating a status of allocation with respect to the candidate allocation time;
train a machine learning model to predict an allocation probability for each candidate allocation time based on the generated training data;
receive a request for a ride from a computing device, the request comprising request attributes; and
process the request attributes using the trained machine learning model to estimate an allocation time for the request.

Generation of training data may comprise generating multiple training records for each historical rideshare allocation record. The candidate allocation time may be based on a predetermined list of potential allocation times. At least one of the predetermined list of potential allocation times may be greater than a largest actual allocation time value in the historical rideshare allocation records.

The trained machine learning model may generate a probability of allocation for one or more of the candidate allocation times; and allocation time for the request is estimated based on a predetermined probability threshold.

In some embodiments, the processor(s) is further configured to transmit the estimated allocation time to the computing device.

In some embodiments, the historical request attributes comprise one or more than one of: ride request location, ride destination information, ride request time, ride request date, requested vehicle type, driver supply indicator and trip demand indicator.

Some embodiments relate to a method for prediction of allocation time in a ridesharing service, the method comprising:
retrieving historical rideshare allocation records, the records comprising actual allocation time values and historical request attributes;
generating training data based on the retrieved historical rideshare allocation records, wherein each record in the training data comprises an allocation status label and a candidate allocation time, the allocation status label indicating a status of allocation with respect to the candidate allocation time;
training a machine learning model to predict an allocation probability for each candidate allocation time based on the generated training data;
receiving a request for a ride from a computing device, the request comprising request attributes; and
processing the request attributes using the trained machine learning model to estimate an allocation time for the request.

### BRIEF DESCRIPTION OF THE DRAWINGS

Some embodiments of systems and methods for prediction of allocation times in a ridesharing service, in accordance with present disclosure, will now be described, by way of non-limiting example only, with reference to the accompanying drawings in which:

FIG. 1 illustrates a block diagram of a system for estimation of allocation time and its associated components; and

FIG. 2 illustrates a flowchart for a method for estimation of allocation time.

### DETAILED DESCRIPTION

Embodiments relate to systems and method for predicting an allocation time for a request for a ridesharing service. Embodiments may include a machine learning model that generates a candidate allocation time specific probability with respect to a request. The machine learning model is trained using historical data relating to rides in a geographical area. The embodiments advantageously provide more accurate estimates of allocation time to requestors of ridesharing services. Provision of more accurate estimates improves the experience and engagement of users with the ridesharing service. The embodiments also provide a low latency method of estimating allocation time as immediate or near real-time estimation of expected allocation times improves the engagement of users with the ridesharing service.

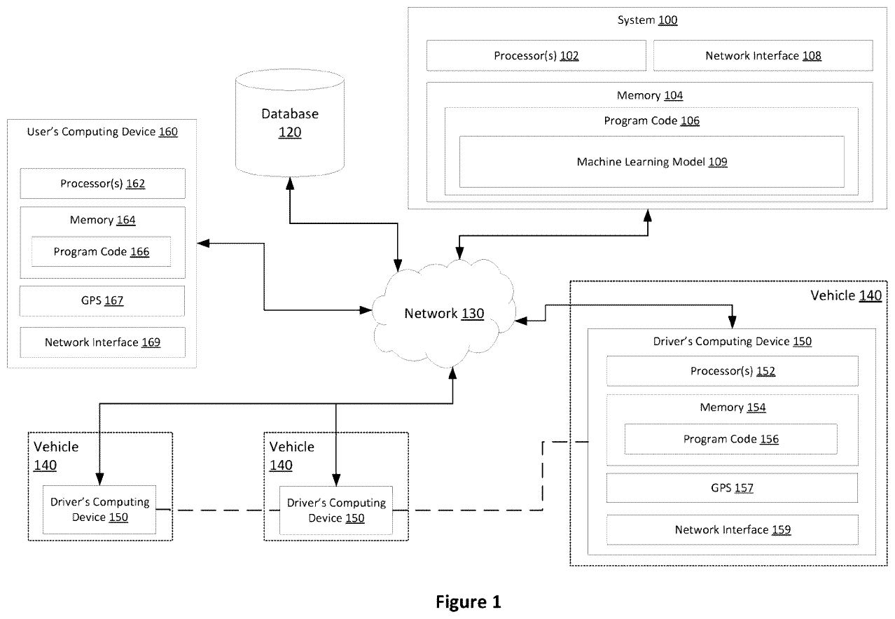

FIG. 1 illustrates a block diagram of a system for estimation of allocation time and its associated components. The system 100 comprises at least one processor 102, memory 104 accessible to the processor 102 and a network interface 108 to facilitate communication with a plurality of driver's computing devices 150 and a user's computing devices 160. Program code 106 provided in memory 104 comprises instructions executable by the processor 102 to perform at least a part of the method of the embodiments described herein. Notably, while individual computer systems are described in FIG. 1, any such computer system may be distributed across multiple servers or multiple devices, or some functionality may be consolidated into a single server or device, without departing from the purposive intent of the present disclosure.

The driver's computing device 150 is associated with a specific vehicle 140 driven by the respective driver. The driver's computing device 150 comprises at least one processor 150, a memory 154, a GPS device 157 and a network interface 159. The memory 154 comprises program code 156 comprising instructions executable by the processor 152 to facilitate interactions with the system 100. The user's computing device 160 comprises one or more processors 162, a memory 164, a GPS device and a network interface 169. The memory 164 comprises program code 166 comprising instructions executable by the processor 162 to facilitate interactions with the system 100. The driver's computing device and the user's computing device may include a personal or handheld computing device such as a smartphone or a tablet. Network 130 facilitates communication between the various devices and may include one or more communication networks including the internet, cell phone networks etc.

One or more database 120 are also accessible to the system 100. The database 120 comprises historical records relating to ridesharing allocation or requests. The historical records may comprise data relating to one or more attributes related to requests for rides comprising one or more of ride request location, ride destination information, ride request time, ride allocation time, requested vehicle type, estimated distance of the trip, estimated time of the trip, a pricing surge multiplier if applicable at the requested time, indicators of supply of drivers at the requested time in the requested location, indicators of demand for rides at the requested time in the requested location etc. The historical records provide a basis for generating insights relating to patterns of allocation of drivers to passengers and enable training of machine learning models to estimate allocation times for future requests. In addition to the historical actual allocation times, the machine learning model may take into account the rest of the data relating to historical rides. For example, the machine learning model may take into account a time of the day a historical ride was requested or a location the historical ride was requested to serve as proxies for availability of drivers. In some embodiments, the machine learning model may take into account historical statistics relating to a supply of drivers in a region proximate to the requester of the ride (driver supply indicator). The driver supply indicator may be an indicator of a number of drivers available for allocation in a defined region proximate to the requester's location at the point of time the ride was requested. In some embodiments, the machine learning model may take into account historical statistics relating to a demand for drivers in a region proximate to the requester of the ride (trip demand indicator). The trip demand indicator may be an indicator of a number of requesters requesting for rides in a defined region proximate to the requester's location at the point of time the ride was requested.

In some embodiments, the historical records in database 120 may comprise information regarding the availability of drivers or number of drivers available in a location that may allow the machine learning model to factor in driver availability in its estimates.

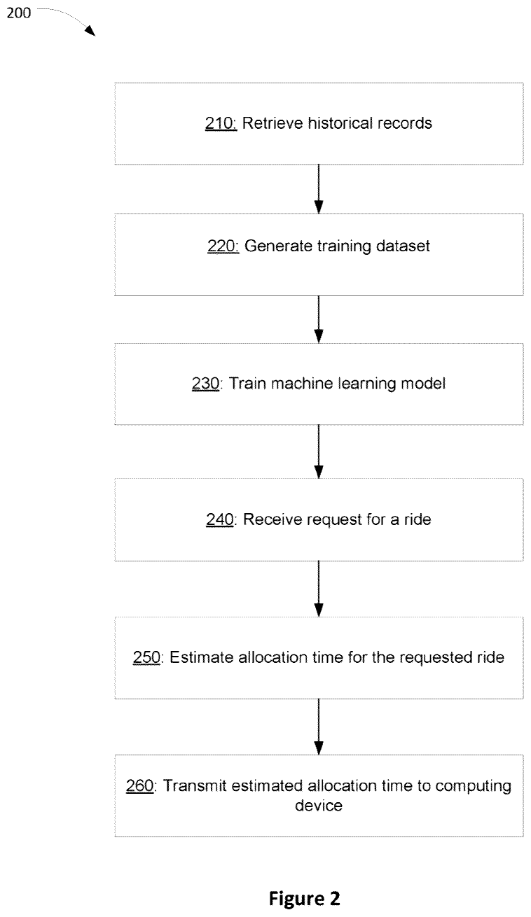

FIG. 2 illustrates a flowchart of a method 200 for prediction of allocation time in a ridesharing service executable by the system 100. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order.

At step 210, the system 100 retrieves historical records from the database 120. The historical records include records relating to past allocations of drivers to passengers, including a time the ride was requested and a time actual allocation occurred. The table below illustrates an example of historical data retrieved at step 210.

TABLE 1
Historical Data

| | | Actual time to |
|---|---|---|
| | | allocate (time |
| | | between the |
| | | request |
| | | initiation |
| | Allocation | and the |
| | status | allocation of |
| Booking | (1 = allocated, | a driver in |
| Ref. | 0 = unallocated) | seconds) |
| 1 | 1 | 15 s |
| 2 | 1 | 25 s |

At step 220, the system 100 generates a training dataset based on the historical allocation records. The training dataset is an expanded training dataset generated based on a predetermined list of potential allocation times. In some embodiments, the predetermined list may include allocation times of 10 s, 20 s, 30 s, 40 s etc. The predetermined list of allocation times may be chosen for a specific region or area depending on the past patterns of allocation. The table below illustrates an example of an expanded training dataset generated based on the historical dataset of Table 1 above using 10 s, 20 s, 30 s as a list of predetermined allocation times.

TABLE 2
Training Data

| | | Actual time to | |
|---|---|---|---|
| | | allocate (time | |
| | Allocation | between the | |
| | status | request | |
| | with respect | initiation | |
| | to candidate | and the | |
| | allocation time | allocation of | Candidate |
| Booking | (1 = allocated, | a driver in | allocation |
| Ref. | 0 = unallocated) | seconds) | time |
| 1 | 0 | 15 s | 10 s |
| 1 | 1 | 15 s | 20 s |
| 1 | 1 | 15 s | 30 s |
| 2 | 0 | 25 s | 10 s |
| 2 | 0 | 25 s | 20 s |
| 2 | 1 | 25 s | 30 s |

The candidate allocation time values are based on a predetermined list of potential allocation times. The allocation status with respect to candidate allocation time is evaluated based on the actual allocation time. For example, for booking ref. 1, the allocation status for candidate times 20 s and 30 s is set to 1 because the actual allocation occurred at 15 s. Similarly, allocation status for booking reference 2 is set to 1 for candidate time 30 s because the actual allocation occurred at 25 s.

At step 230, the machine learning model 109 is trained by the system using the training data generated at step 220. The machine learning model is trained to estimate allocation probability within a candidate allocation time since the initiation of the request. For example, in the table below, the machine learning model 109 is trained to estimate probability for a booking request/ridesharing request 3 that has not been fulfilled.

TABLE 3
Training Data

| | | Actual time to | |
|---|---|---|---|
| | | allocate (time | |
| | Allocation | between the | |
| | status | request | |
| | with respect | initiation | |
| | to candidate | and the | |
| | allocation time | allocation of | Candidate |
| Booking | (1 = allocated, | a driver in | allocation |
| Ref. | 0 = unallocated) | seconds) | time |
| 1 | 0 | 15 s | 10 s |
| 1 | 1 | 15 s | 20 s |
| 1 | 1 | 15 s | 30 s |
| 2 | 0 | 25 s | 10 s |
| 2 | 0 | 25 s | 20 s |
| 2 | 1 | 25 s | 30 s |
| 3 | <allocation probability | Unknown | 10 s |
| | prediction> | | |
| 3 | <allocation probability | Unknown | 20 s |
| | prediction> | | |
| 3 | <allocation probability | Unknown | 30 s |
| | prediction> | | |

The machine learning model 109 may comprise a classification model that generates the probability of classification of a ridesharing request to a specific candidate allocation time. The generation of training data provides the flexibility of designating a suitable enumeration of candidate allocation times that may include values larger than the largest actual allocation time in the historical allocation records. The interval between the candidate allocation times may be determined in a manner to optimize the number of candidate allocation times such that there is a balance between sparsity and density in the search space. For example, with an intended maximum allocation time of 600 s, the candidate allocation times used may be 30 s, 60 s . . . 570 s, 600 s. The interval between the candidate allocation times may be varied to optimize the need for memory or compute power during training of the machine learning mode and/or execution of the trained machine learning model. The machine learning model 109 may comprise a neural network based classification model, or a decision tree based classification model, or a linear classification model, or a support vector machine, or an ensemble learning based model etc. Parameters of the machine learning model 109 are defined/optimized during the training process to obtain a trained machine learning model.

In some embodiments, the machine learning model 109 may be a boosted tree based model such as a model implemented using XGBoost. Optimal hyperparameters of the machine learning model 109 may be determined using parameter optimization methods such as a grid search method or a random search method for hyperparameter optimization.

By generating the training dataset and training the machine learning model to predict a probability of allocation in relation to a candidate allocation time, the embodiments transform the regression problem of estimating allocation time (a continuous variable) into a classification problem associated with discrete variables. The classification based machine learning model 109 provides a more improved estimation performance at the expense of the possibility of prediction of allocation times as a continuous variable. In some embodiments, at least one of the predetermined list of potential allocation times/candidate allocation times is greater than a largest actual allocation time value in the historical rideshare allocation records. The ability to perform predictions in relation to the predetermined list of allocation times provides the flexibility of training the machine learning models for future allocation time values that may not have been anticipated based on the historical data.

Steps 240, 250 and 260 relate to use of the trained machine learning model for estimation of allocation times. At step 240, the system 100 receives a request for estimation of allocation times. The request may be received directly from a user's computing device 160 or through an intermediary computer system that conveys the details of the request to system 100. The request comprises request attributes relating to the request that may include: time of request, origin location of the ride, destination of the ride, type of vehicle requested etc. The request parameters are provided as input to the machine learning model 109 which generates an estimated allocation time at step 250. The machine learning model 109 outputs a probability for each value of candidate allocation time. The estimated allocation time may be chosen from one of the candidate allocation time values with a probability value greater than a predefined threshold or a value with the largest probability. Table 4 below illustrates an example output/prediction values obtained in response to booking ref. 3 of Table 3.

TABLE 4
Allocation time probability estimates

| | Allocation | |
|---|---|---|
| | status | |
| | with respect | |
| | to candidate | |
| | allocation time | |
| Booking | (1 = allocated, | Generated |
| Ref. | 0 = unallocated) | wait time |
| 3 | 0.3 | 10 s |
| 3 | 0.4 | 20 s |
| 3 | 0.5 | 30 s |

For example, if the threshold is set to 0.35, based on the results of Table 4, the allocation time estimate of 20 s may be provided as an output. As noted in Tables 3 and 4, each incoming/new request for a ridesharing service is evaluated with respect to each value in the candidate allocation times. At step 260, the allocation time estimate obtained at step 250 is transmitted to the user's computing device 160 or an intermediary system that ultimately makes the allocation time estimate available to the user's computing device. The user's computing device may display the estimate on its display or user interface.

Steps 240, 250 and 260 may be performed in parallel for each request for a ridesharing service. Steps 210, 220 and 230 may be performed periodically, for example every day, every week or every month to update/retrain the machine learning model 109 using new ridesharing allocation data as it becomes available.

Time as referred to in this specification may relate to a specific time or an interval of time. Allocation time estimates may be an estimate of allocation of a driver to a passenger by a specific time or an estimated time interval between the initiation of the ridesharing request and an anticipated allocation of a driver.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Although this disclosure describes or illustrates particular embodiments as providing particular advantages, particular embodiments may provide none, some, or all of these advantages.

1. A system for prediction of allocation time in a ridesharing service, the system comprising:
one or more processor (processor(s));
a memory comprising instructions that when executed by the processor(s) cause the processor(s) to:
retrieve historical ridesharing allocation records, the records comprising actual allocation time values and historical request attributes;
generate training data based on the retrieved historical rideshare allocation records, wherein each record in the training data comprises an allocation status label and a candidate allocation time, the allocation status label indicating a status of allocation with respect to the candidate allocation time;
train a machine learning model to predict an allocation probability for each candidate allocation time based on the generated training data;
receive a request for a ride from a computing device, the request comprising request attributes; and
process the request attributes using the trained machine learning model to estimate an allocation time for the request.

2. The system of claim 1, wherein generation of training data comprises generating multiple training records for each historical rideshare allocation record.

3. The system of claim 1, wherein the candidate allocation time is based on a predetermined list of potential allocation times.

4. The system of claim 3, wherein at least one of the predetermined list of potential allocation times is greater than a largest actual allocation time value in the historical rideshare allocation records.

5. The system of claim 1, wherein the trained machine learning model generates a probability of allocation for one or more of the candidate allocation times; and
allocation time for the request is estimated based on a predetermined probability threshold.

6. The system of claim 1, wherein the processor(s) is further configured to transmit the estimated allocation time to the computing device.

7. The system of claim 1, wherein the historical request attributes comprise one or more than one of: ride request location, ride destination information, ride request time, ride request date, requested vehicle type, driver supply indicator and trip demand indicator.

8. A method for prediction of allocation time in a ridesharing service, the method comprising:
retrieving historical rideshare allocation records, the records comprising actual allocation time values and historical request attributes;
generating training data based on the retrieved historical rideshare allocation records, wherein each record in the training data comprises an allocation status label and a candidate allocation time, the allocation status label indicating a status of allocation with respect to the candidate allocation time;
training a machine learning model to predict an allocation probability for each candidate allocation time based on the generated training data;
receiving a request for a ride from a computing device, the request comprising request attributes; and
processing the request attributes using the trained machine learning model to estimate an allocation time for the request.

9. The method of claim 8, wherein generation of training data comprises generating multiple training records based on each historical rideshare allocation record.

10. The method of claim 8, wherein the candidate allocation time is based on a predetermined list of potential allocation times.

11. The method of claim 8, wherein at least one of the predetermined list of potential allocation times is greater than a largest actual allocation time value in the historical rideshare allocation records.

12. The method of claim 8, wherein the trained machine learning model generates a probability of allocation for one or more of the candidate allocation times; and
allocation time for the request is estimated based on a predetermined probability threshold.

13. The method of claim 8 further comprising transmitting the estimated allocation time to the computing device.

14. The method of claim 8, wherein the historical request attributes comprise one or more than one of: ride request location, ride destination information, ride request time, ride request date, requested vehicle type, driver supply indicator and trip demand indicator.
